(19) United States
(12) Patent Application Publication
(10) Pub. No.: US 2015/0348410 A1
(43) Pub. Date: Dec. 3, 2015

(54) METHOD AND APPARATUS FOR ESTIMATING TIME TO ARRIVAL OF TRANSPORTATION

(71) Applicant: LG CNS CO., LTD., Seoul (KR)

(72) Inventor: Kyong Hoon MIN, Seoul (KR)

(73) Assignee: LG CNS CO., LTD., Seoul (KR)

(21) Appl. No.: 14/292,773

(22) Filed: May 30, 2014

(51) Int. Cl. G08G 1/01

(52) U.S. Cl. CPC G08G 1/0125

(57) ABSTRACT

Embodiments are directed to a method, a system, and an apparatus that estimate an arrival time of a vehicle. A method according to an embodiment includes measuring travel times of a plurality of vehicles through a section in a transportation route using location information on the plurality of vehicles, calculating travel times using at least one of a moving average, exponential smoothing, and a service pattern of the plurality of vehicles with respect to the section using the measured travel times of the plurality of vehicles, calculating an error value between a measured travel time of a first vehicle with respect to the section and each travel time calculated using at least one of the moving average, the exponential smoothing, and the service pattern, and estimating a travel time of a second vehicle with respect to the section, based on the calculated error value.

### BACKGROUND

The background section provided herein is for the purpose of generally presenting context for the present disclosure. Work of the presently named inventors, to the extent the work is described in this section, as well as aspects of the description that may not otherwise qualify as prior art at the time of filing, are neither expressly nor impliedly admitted as prior art against the present disclosure.

Research has been conducted into technologies for estimating the arrival time of a transportation vehicle so as to manage a transportation service schedule and provide convenient service to transportation passengers. For example, Korean Patent Application Laid-Open No. 10-2004-0086675 discloses an apparatus and a method for calculating an estimated arrival time.

According to the related art, a target station, for which the estimated arrival time is to be calculated, is selected from a route map on which station identification information and location information for each line of transportation are recorded. Line numbers of the lines of transportation passing through the selected target station and current locations of vehicles traveling through routes corresponding to the line numbers are obtained. The remaining distance to the selected target station is calculated based on current locations of vehicles nearest to the selected target station among the vehicles which travel through the routes corresponding to the respective line numbers passing through the selected target station. Estimated arrival times of the vehicles nearest to the selected target station are calculated using a disclosed mathematical expression.

However, the related art estimates the arrival time of a transportation vehicle based on a single algorithm, leading to degradation in accuracy.

### SUMMARY

Embodiments described herein provide methods capable of increasing the accuracy of arrival time estimation of a transportation vehicle.

In addition, embodiments described herein provide sections divided according to service characteristics of transportation.

Furthermore, embodiments described herein provide various algorithms capable of being applied to arrival time estimation of a transportation vehicle.

Moreover, embodiments described herein provide methods capable of accurately estimating an arrival time of a transportation vehicle by using various algorithms.

Embodiments are directed to a method, a system, and an apparatus that estimate an arrival time of a vehicle. A method according to an embodiment includes measuring travel times of a plurality of vehicles through a section in a transportation route using location information on the plurality of vehicles, calculating travel times using at least one of a moving average, exponential smoothing, and a service pattern of the plurality of vehicles with respect to the section using the measured travel times of the plurality of vehicles, calculating an error value between a measured travel time of a first vehicle with respect to the section and each travel time calculated using at least one of the moving average, the exponential smoothing, and the service pattern, and estimating a travel time of a second vehicle with respect to the section, based on the calculated error value.

In addition, in an embodiment, a section includes at least one of a first section between a first intersection and a first station adjacent to the first intersection, a second section between the first intersection and a second intersection adjacent to the first intersection, and a third section between the first station and a second station adjacent to the first station, and calculating the travel times comprises calculating travel times of the plurality of vehicles through the first section and calculating travel times of the plurality of vehicles through the second section and the third section, based on the travel time of the plurality of vehicles through the first section.

In a method in accordance with an embodiment, the travel time through the section includes a stoppage time of a vehicle at a station located in the section.

In a method in accordance with an embodiment, the moving average is calculated based on a cumulative operation frequency of the plurality of vehicles and a cumulative operation time of the plurality of vehicles.

In a method in accordance with an embodiment, service patterns may include patterns of transportation service provided based on seasons, weather, day of the week, time, and characteristics of the section.

In a method in accordance with an embodiment, estimating the travel time of the second vehicle includes estimating, as the travel time of the second vehicle, a value having the smallest error value with respect to the measured travel time of the first vehicle with respect to the section among the travel times calculated using the moving average, the exponential smoothing, and the service pattern.

In addition, a method in accordance with an embodiment may further include filtering a value, which is outside of a predefined range, among the measured travel times of the plurality of vehicles.

In addition, a method in accordance with an embodiment may further include determining a traffic condition of the section, based on the travel times calculated using the moving average, the exponential smoothing, and the service pattern.

According to embodiments described herein, transportation service providers can provide high-quality services to transportation passengers.

In addition, according to embodiments described herein, the reliability of transportation services can be improved.

Furthermore, according to embodiments described herein, an operator of a transportation vehicle can stably operate the transportation vehicle.

Moreover, according to embodiments described herein, transportation passengers can use services while accurately estimating the time it will take to use a transportation vehicle.

### BRIEF DESCRIPTION OF THE DRAWINGS

FIG. 1 is a diagram illustrating a system for estimating an arrival time of a transportation vehicle according to an embodiment.

FIG. 2 is a diagram illustrating sections divided according to service characteristics of transportation according to an embodiment.

FIG. 3 is a flowchart illustrating a method for estimating an arrival time of a transportation vehicle according to an embodiment.

FIG. 4 is a diagram illustrating a structure of a database according to an embodiment.

FIG. 5 is a diagram illustrating a method for calculating a representative value according to an embodiment.

FIG. 6 is a diagram illustrating a method for estimating an arrival time of a transportation vehicle according to an embodiment.

FIG. 7 is a block diagram illustrating an arrival time estimation apparatus according to an embodiment.

### DESCRIPTION OF SPECIFIC EMBODIMENTS

Hereafter, embodiments of the present disclosure will be described below in more detail with reference to the accompanying drawings. Throughout the drawings, like reference numerals refer to like parts.

The following embodiments may be modified in various ways without departing from the spirit and scope of the disclosure. Thus, embodiments are not limited by the embodiments specifically described herein, but may include modifications, equivalents or substitutes thereof.

The terms used to describe embodiments are used for the purpose of explaining the specific embodiment, and do not limit embodiments. Terms referring to a feature of an embodiment in singular form do not exclude the possibility of plural forms unless the contrary is indicated. In this specification, the meaning of “include/comprise” or “have” specifies a property, a figure, a step, a process, an element, a component, or a combination thereof which is described in the specification, but does not exclude one or more other properties, numbers, steps, processes, elements, components, or combinations thereof.

Terms used herein that may be technical or scientific terms have the same meanings as the terms which are generally understood by those skilled in the art to which the present disclosure pertains, unless they are differently defined or a different meaning is clear from context. Terms that may be defined in a generally used dictionary may be interpreted to have meanings which coincide with contextual meanings in the related art. Unless a term is clearly defined in this specification, the term may not be interpreted as having an excessively formal or technical meaning.

In the accompanying drawings, like reference numerals refer to like elements, and duplicated descriptions thereof may be omitted. Detailed descriptions of well-known functions or configurations may be omitted so that embodiments of the present disclosure are not unnecessarily obscured.

Passenger transportation vehicles, such as buses, trains, electric cars, railways, subways, trams, automobiles, two-wheeled vehicles, and the like, travel through predefined travel pathways or routes.

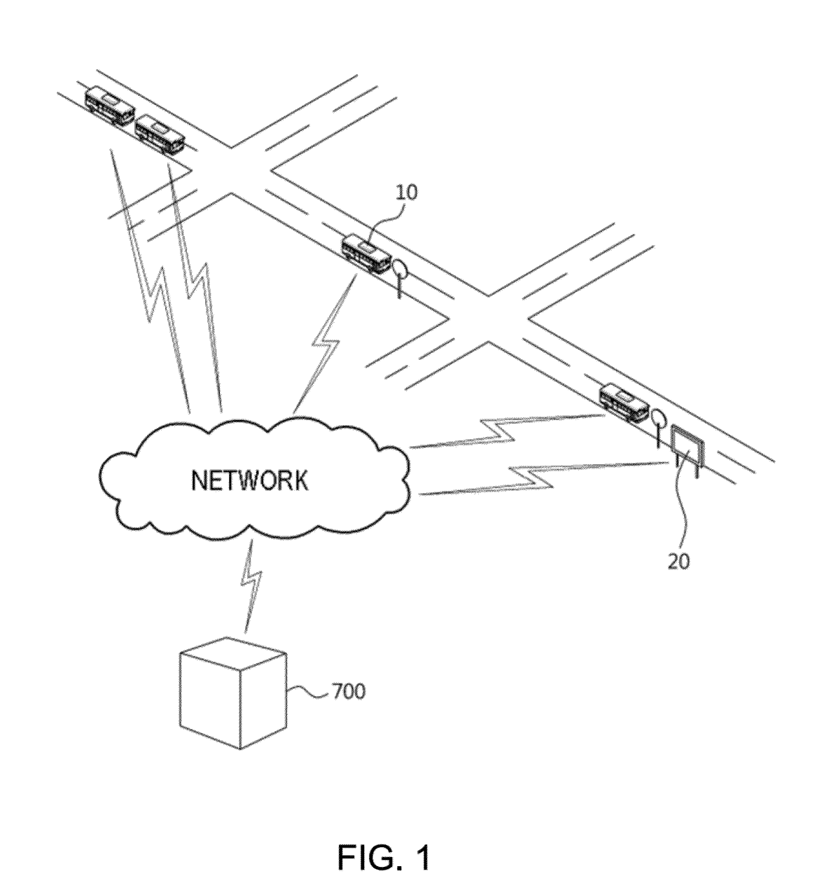

FIG. 1 is a diagram illustrating a system for estimating an arrival time of a transportation vehicle according to an embodiment.

Referring to FIG. 1, a system for estimating an arrival time of a transportation vehicle includes a plurality of vehicles 10, an information output apparatus 20, which provides transportation information, and an arrival time estimation apparatus 700, which estimates an arrival time of a vehicle.

The plurality of vehicles 10, the transportation information output apparatus 20, and the arrival time estimation apparatus 700 may be connected through a wired or wireless network.

The plurality of vehicles 10 may transmit vehicle location information (i.e., information on the location of the plurality of vehicles 10) to the arrival time estimation apparatus 700. The vehicle location information may include Global Positioning System (GPS) information or information obtained from Radio-Frequency Identification (RFID) tags installed on traveling paths.

The arrival time estimation apparatus 700 may estimate the arrival time of each of the plurality of vehicles 10 by using the vehicle location information. In addition, the arrival time estimation apparatus 700 may transmit the estimated arrival times of the plurality of vehicles 10 to the transportation information output apparatus 20.

The arrival time estimation apparatus 700 may be located at a control facility that is separate from the plurality of vehicles 10 and the transportation information output apparatus 20. In other embodiments, the arrival time estimation apparatus 700 may be provided in the plurality of vehicles 10, or may be provided in the transportation information output apparatus 20.

The arrival time estimation apparatus 700 may estimate the arrival time of the plurality of vehicles 10 with respect to sections of a route or travel pathway of a line of transportation. A route or travel pathway may be divided into sections based on intersections and stations, by using various algorithms.

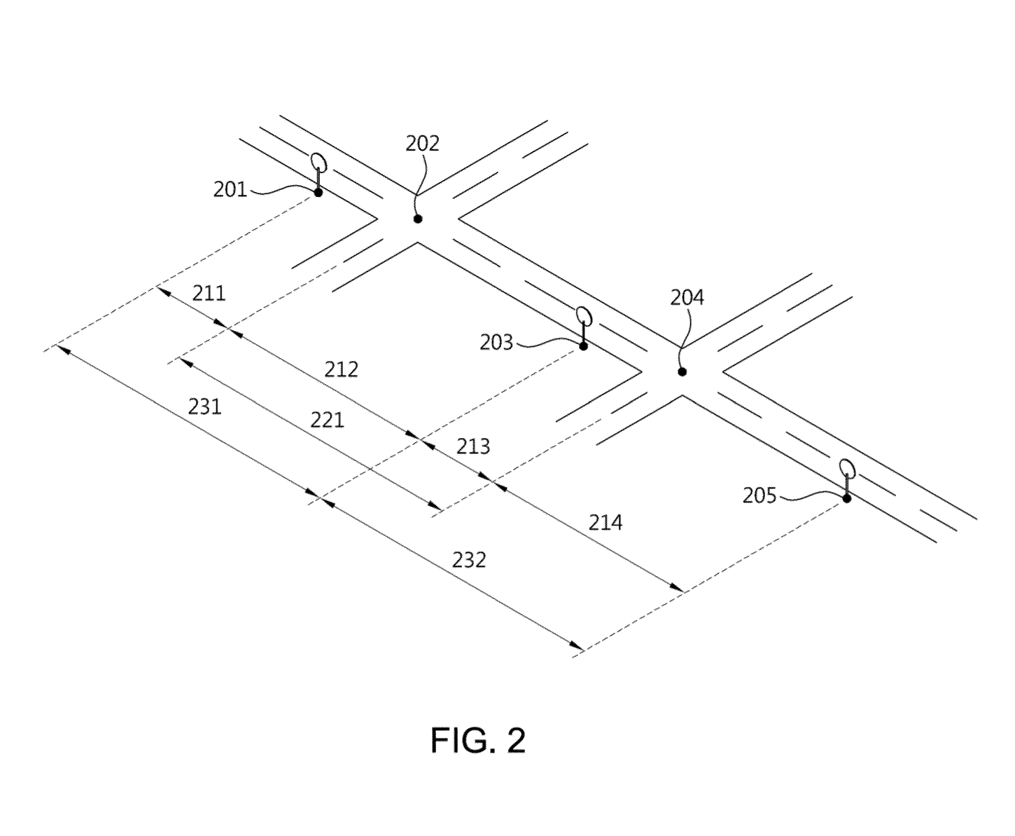

A method for estimating an arrival time of a transportation vehicle in accordance with an embodiment will be described below with reference to FIGS. 2 to 6.

The transportation information output apparatus 20 may provide a variety of information to transportation passengers. The information provided by the transportation information output apparatus 20 may include the estimated arrival time of the plurality of vehicles 10, the number of stations remaining in a transportation route, information on the nearest vehicle, information on the last vehicle to arrive at a station, route information, advertisements, weather information, news information, and the like.

The transportation information output apparatus 20 may be installed at a transportation station. For example, the transportation information output apparatus 20 may be a display or reader board. In another embodiment, the transportation information output apparatus 20 may be a passenger's mobile terminal. That is, the arrival time estimation apparatus 700 may transmit a variety of information to a passenger's mobile terminal. In an embodiment, the transportation information output apparatus 20 includes a display screen and outputs information visually. However, embodiments are not limited thereto. The transportation information output apparatus 20 may output information in a visual format, an audio format, as haptic feedback, or any combination thereof.

The vehicle information may be classified and provided based on a predefined number of remaining stations or a predefined estimated arrival time. For example, detailed vehicle information may be provided when the number of the remaining stations is five or less, or when the estimated arrival time is ten minutes or less.

FIG. 2 is a diagram illustrating sections of a transportation route that is divided according to transportation service characteristics according to an embodiment.

Referring to FIG. 2, sections of the transportation route may be divided into first sections 211, 212, 213 and 214, a second section 221, and third sections 231 and 232.

The first sections 211, 212, 213 and 214 are sections between intersections and stations adjacent to the intersections. For example, the first sections 211, 212, 213 and 214 include a section between a station 201 and an intersection 202, a section between the intersection 202 and a station 203, a section between the station 203 and an intersection 204, and a section between the intersection 204 and a station 205, respectively.

The second section 221 is a section between adjacent intersections. For example, the second section 221 is a section between the intersection 202 and the intersection 204.

The third sections 231 and 232 are sections between adjacent stations. For example, the third sections 231 and 232 are a section between the station 201 and the station 203 and a section between the station 203 and the station 205, respectively.

The arrival time estimation apparatus 700 may estimate the travel time of each of the plurality of vehicles 10 with respect to each section, thereby increasing the accuracy of the arrival time estimation.

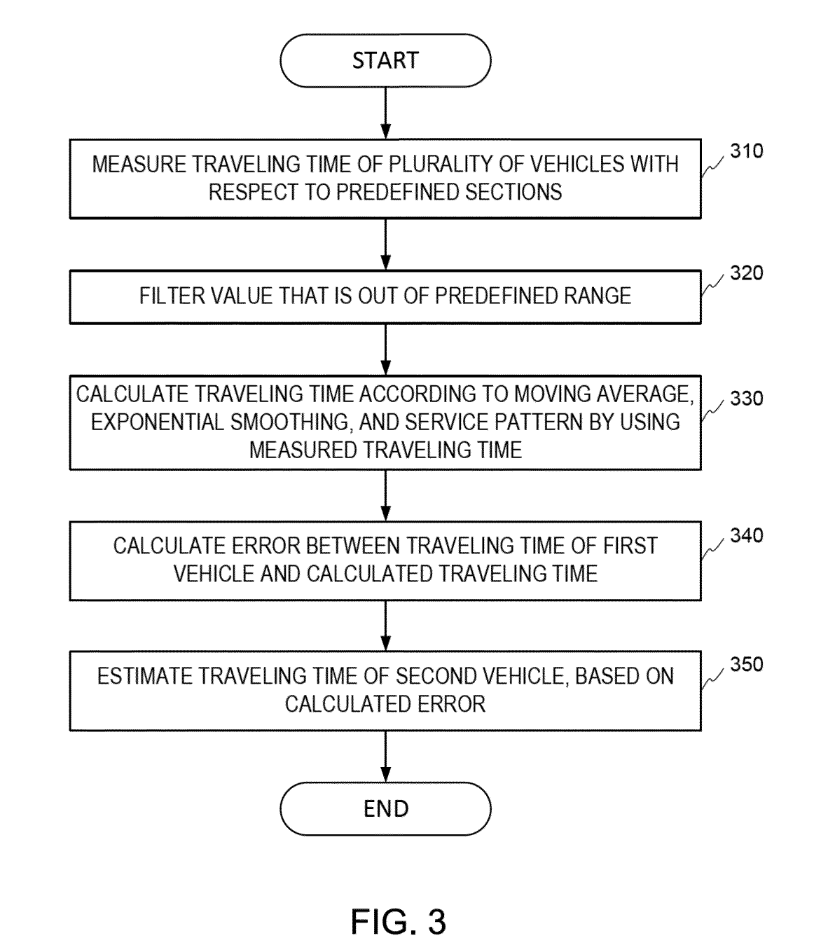

FIG. 3 is a flowchart illustrating a method for estimating the arrival time of a transportation vehicle according to an embodiment.

Referring to FIG. 3, at step 310, the arrival time estimation apparatus 700 measures the travel time of each of the plurality of vehicles 10 with respect to the predefined sections by using the location information on the plurality of vehicles 10. That is, the arrival time estimation apparatus 700 determines the time it takes for a vehicle to travel through the predefined sections. The predefined sections may include the first sections 211, 212, 213 and 214, the second section 221, and the third sections 231 and 232.

The arrival time estimation apparatus 700 may measure the travel times of the plurality of vehicles 10 with respect to the first sections 211, 212, 213 and 214, the second section 221, and the third sections 231 and 232 by using a passage time, i.e., the time when a vehicle has passed through any of the stations 201, 203 and 205 and the intersections 202 and 204. For example, the travel time of one of the plurality of vehicles 10 with respect to the first section 211 may be calculated using the difference between the time when the vehicle passed through the intersection 202 and the time when the vehicle passed through the station 201.

The arrival time estimation apparatus 700 may calculate the travel times of the plurality of vehicles 10 through the second section 221 and the third sections 231 and 232, based on the travel times of the plurality of vehicles 10 through the first sections 211, 212, 213 and 214.

For example, the arrival time estimation apparatus 700 may calculate the travel times of the plurality of vehicles 10 through the second section 221, based on the travel times of the plurality of vehicles 10 through the first sections 212 and 213. In addition, the arrival time estimation apparatus 700 may calculate the travel times of the plurality of vehicles 10 through the third section 231, based on the travel times of the plurality of vehicles 10 through the first sections 211 and 212.

The arrival time estimation apparatus 700 can reduce redundant calculations by calculating the travel times of the plurality of vehicles 10 through the second section 221 and the third sections 231 and 232, based on the travel times of the plurality of vehicles 10 through the first sections 211, 212, 213 and 214. Thus, a method in accordance with an embodiment can reduce the load on a processor that determines the travel times, and reduce the amount of time it takes to make such calculations.

At step 320, the arrival time estimation apparatus 700 filters a value that is outside of a predefined range. In an embodiment, the predefined range may refer to a range of velocity. A predefined range may correspond to a range of velocities that are considered within a range of normal operation of a vehicle providing a transportation service, and a value outside of the predefined range may correspond to a velocity that is not considered normal in the operation of the transportation vehicle. For example, the arrival time estimation apparatus 700 may filter a value of 3 km or less or a value of 110 km or more.

At step 330, the arrival time estimation apparatus 700 calculates travel times according to a moving average, exponential smoothing, and a service pattern by using the measured travel times of the plurality of vehicles 10. The calculated travel times, which are calculated according to the moving average, the exponential smoothing, and the service pattern of the plurality of vehicles 10, may be calculated for each predefined section.

The moving average Mt may be calculated using Formula 1 below.

$${M}_{t} = \frac{{\sum }_{n = 1}^{R} {B}_{n}}{{\sum }_{n = 1}^{R} {A}_{n}} \qquad [ Formula 1 ]$$

The moving average Mt is calculated based on a cumulative operation frequency of the plurality of vehicles and a cumulative operation time of the plurality of vehicles 10. The cumulative operation frequency may correspond to the number of times the plurality of vehicles travels through a section in a predetermined time period, and the cumulative operation time may represent a sum of the total time taken for the plurality of vehicles 10 to travel through the section.

In Formula 1, “A” is the cumulative operation frequency of the plurality of vehicles 10, and “B” is the cumulative operation time of the plurality of vehicles 10. The cumulative operation frequency may be reset when the calculated moving average Mt changes beyond a predefined range. For example, when the change in the moving average Mt is one minute or more, the cumulative operation frequency may be reset so that service frequency is recounted from 0.

The moving average Mt may be calculated based on data aggregated for a predefined time period. For example, the moving average Mt may be calculated based on data aggregated for the last fifteen minutes.

The exponential smoothing Et may be calculated using Formulas 2 and 3 below.

$$\begin{matrix}E = T 1 \times e + T 2 \times ( 1 - e ) & [ Formula 2 ] \\ {E}_{t} = \frac{{\sum }_{n = 1}^{R} E}{R} & [ Formula 3 ]\end{matrix}$$

In Formula 2, T1 and T2 are recently collected operation times, e is an exponential value, and R is a time interval for which the exponential smoothing is to be calculated. In an embodiment, a default value of e is 0.7.

The service pattern Pt may be a pattern of transportation service provided based on various factors that affect travel conditions, such as seasons, weather, day of the week, time, and characteristics of the predefined sections. For example, travel time according to the service pattern may be the travel time of the plurality of vehicles 10 in the first section 211 when it rains. In an embodiment, service patterns are preset and applied to a section of a route.

In calculating the travel times according to the service pattern, one or more service patterns may be considered. The arrival time estimation apparatus 700 may calculate an error rate for the plurality of service patterns. In addition, the arrival time estimation apparatus 700 may use the error rate to estimate the arrival time of a second vehicle.

Traffic conditions in the predefined sections may be determined based on the travel times that are calculated using the moving average, the exponential smoothing, and the service pattern. The traffic condition may include “free flow”, “hold-up”, and “congestion”. Different criteria may be applied to determine the traffic conditions for each predefined section. The arrival time estimation apparatus 700 may transmit the traffic conditions to the transportation information output apparatus 20.

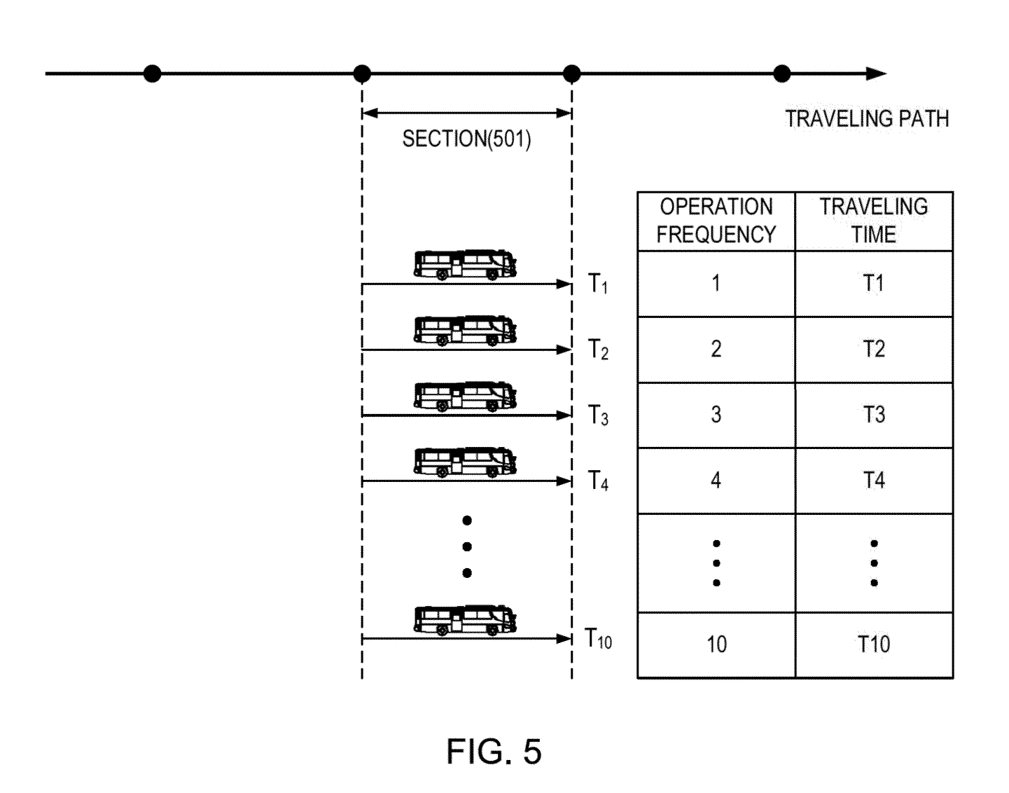

The travel times calculated using the moving average, the exponential smoothing, and the service pattern may be calculated using a representative value. A representative value in accordance with an embodiment will be described with reference to FIG. 5.

At step 340, the arrival time estimation apparatus 700 calculates an error value between a measured actual travel time of a first vehicle and each calculated travel time. That is, the arrival time estimation apparatus 700 calculates an error value between the travel times of the plurality of vehicles 10, which are calculated based on the moving average, the exponential smoothing, and the service pattern, and which is calculated at step 330, and the actual travel time of the first vehicle.

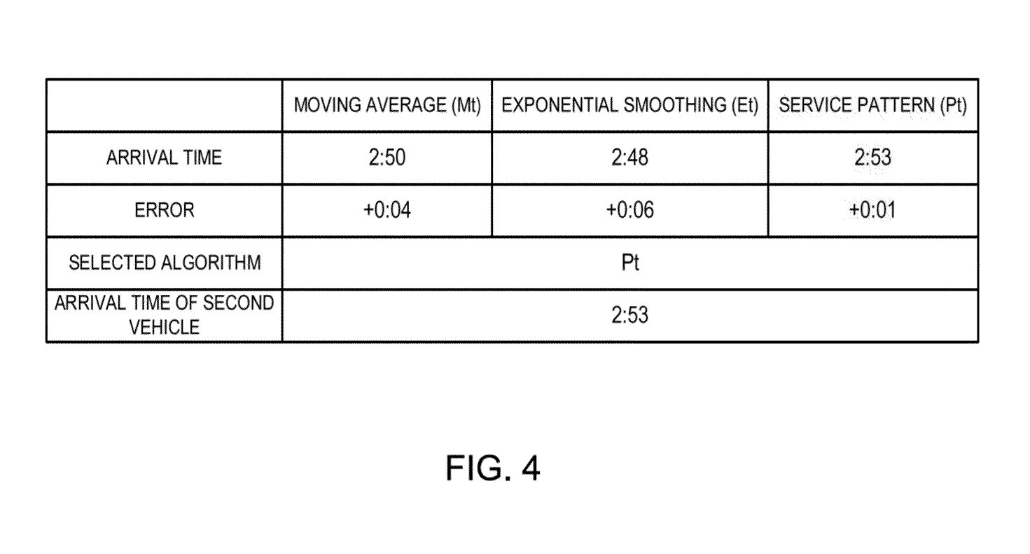

The first vehicle refers to vehicle that arrives at a target station after sample data is generated using the travel times of the plurality of vehicles 10. The above error calculation may be performed on more than one vehicle. That is, a plurality of vehicles may be used as the first vehicle. The target station refers to a station at which the arrival time of the vehicle is calculated. An error calculation process in accordance with an embodiment will be described with reference to FIG. 4.

At step 350, the arrival time estimation apparatus 700 estimates a travel time of a second vehicle based on the calculated error value. The arrival time estimation apparatus 700 may determine, as the travel time of the second vehicle, a value having the smallest error value with respect to the actual travel time of the first vehicle, among the travel times that were calculated according to the moving average, the exponential smoothing, and the service pattern.

Thus, the arrival time estimation apparatus 700 may estimate the arrival time of the second vehicle by applying different algorithms to the respective predefined sections. The algorithms may include the moving average, the exponential smoothing, and the service pattern.

The second vehicle refers to vehicle that arrives at the target station after the first vehicle has arrived at the target station. That is, the second vehicle is the vehicle targeted to estimate its arrival time.

The arrival time estimation apparatus 700 may estimate the arrival time of the second vehicle, considering the estimated travel time of the second vehicle. The arrival time estimation apparatus 700 may transmit arrival information including the estimated arrival time of the second vehicle to the transportation information output apparatus 20. The transportation information output apparatus 20 may provide the arrival information on the second vehicle to transportation passengers.

FIG. 4 is a diagram illustrating a structure of a database according to an embodiment.

Referring to FIG. 4, the database includes an arrival time, an error value, a selected algorithm, and an estimated arrival time of a second vehicle. That is, the database stores calculations based on the travel times determined using the moving average, the exponential smoothing, and the service pattern.

The arrival time estimation apparatus 700 may generate and manage a database including a table illustrated in FIG. 4 with respect to each predefined section. A predefined section may include at least one of a first section between a first intersection and a first station adjacent to the first intersection, a second section between the first intersection and a second intersection adjacent to the first intersection, and a third section between the first station and a second station adjacent to the first station.

The travel times according to the moving average and the exponential smoothing may be calculated using Formulas 1 to 3 described above with reference to FIG. 3. In addition, the service pattern may include patterns of transportation services provided based on seasons, weather, day of the week, time, and characteristics of the predefined sections. A travel time according to a service pattern may be calculated based on the listed service patterns.

The arrival time in the database may be calculated based on the travel time from the current location of the vehicle to the target station. The error value may be calculated from a difference between the actual arrival time when the first vehicle arrives at the target station and the calculated arrival times of the plurality of vehicles.

The arrival time estimation apparatus 700 may select, as the arrival time of the second vehicle, a value having the smallest error value among the arrival times calculated based on the travel times according to the moving average, the exponential smoothing, and the service pattern. For example, when the arrival time of the first vehicle is 2:54, the arrival time estimation apparatus 700 may determine the arrival time of the second vehicle using the travel time according to the service pattern, i.e., 2:53, which has the smallest error value, in FIG. 4.

The arrival time estimation apparatus 700 may select the algorithm to be applied to determine the arrival time of the second vehicle with respect to each of the plurality of predefined sections, based on the algorithm used to obtain the smallest calculated error value.

FIG. 5 is a diagram illustrating a method for calculating a representative value according to an embodiment.

Referring to FIG. 5, a section 501 located on a travel path and travel times according to the frequency of operation on the travel path are illustrated. The section 501 is one of the predefined sections.

The arrival time estimation apparatus 700 may calculate the travel times according to a moving average, an exponential smoothing, and a service pattern, based on the representative value. For example, the arrival time estimation apparatus 700 may calculate a cumulative operation frequency and a cumulative operation time based on travel times within a confidence interval among measured travel times of a plurality of vehicles. The arrival time estimation apparatus 700 may calculate the moving average using the calculated cumulative operation frequency and the calculated cumulative operation time.

In addition, the arrival time estimation apparatus 700 may calculate the exponential smoothing using travel times within the confidence interval among recently collected travel times.

Moreover, the arrival time estimation apparatus 700 may calculate a moving time according to a service pattern by considering service patterns provided based on seasons, weather, day of the week, time, and characteristics of the predefined sections, which only correspond to the travel times within the confidence interval.

The representative value S(t) may be calculated using Formula 4 below.

$$S ( t ) = \{ {\sum }_{n = 1}^{10} T ( n ) - {T}_{a} \} \times \frac{1}{n - a} \qquad [ Formula 4 ]$$

Formula 4 represents a method for calculating the representative value S(t) when n is 10, where “n” represents an operation frequency corresponding to the number of times the section 501 is traveled through. In an embodiment, n is designated in the range from 1 to 10. T(n) represents a travel time value of each operation. Ta represents service time values that are outside of a confidence interval, where “a” represents the number of the service time values that are outside of the confidence interval. Formula 4 may be expressed as Formula 5 below.

$$S ( t ) = \frac{{T}_{1} + {T}_{2} + {T}_{3} + … + {T}_{8}}{8} \qquad [ Formula 5 ]$$

Referring to Formula 5, the representative value S(t) may be calculated by dividing the sum of the service time values included in the confidence interval by the number of the service time values included in the confidence interval. The confidence interval may be adjusted. For example, the representative value may have a 95% confidence interval or an 85% confidence interval.

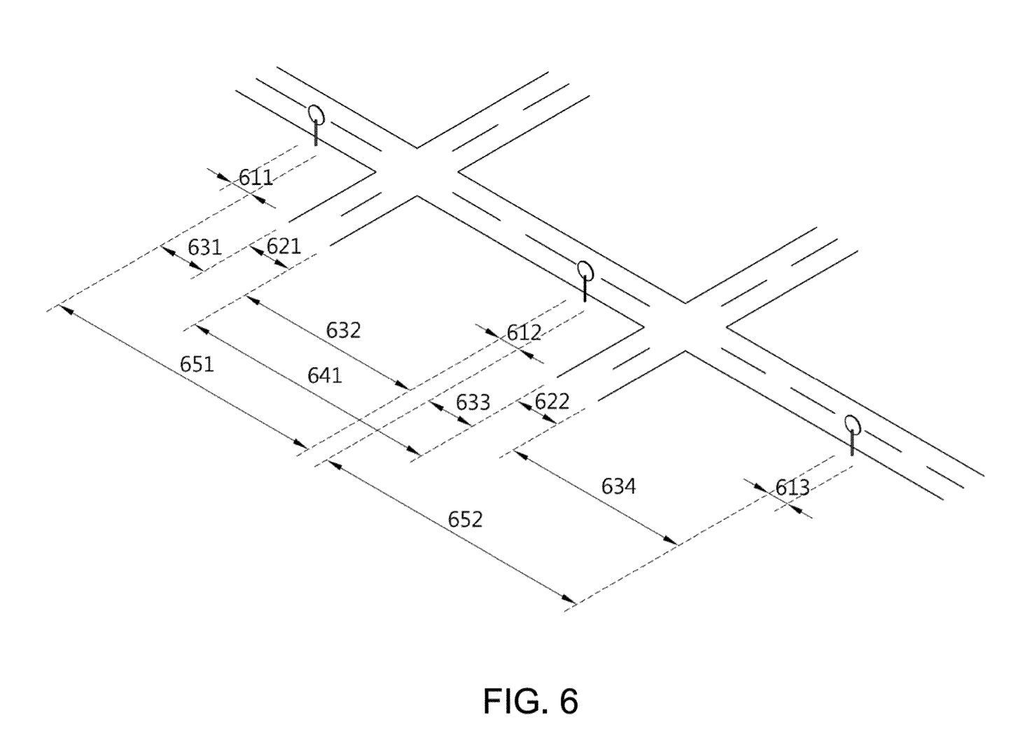

FIG. 6 is a diagram illustrating a method for estimating the arrival time of a transportation vehicle according to an embodiment.

Referring to FIG. 6, travel sections of transportation vehicle may be divided into station sections 611, 612 and 613, intersection sections 621 and 622, first sections 631, 632, 633 and 634, a second section 641, and third sections 651 and 652. The sections illustrated in FIG. 6 include the station sections 611, 612 and 613 and the intersection sections 621 and 622, in which traffic congestion may occur.

The arrival time estimation apparatus 700 may consider a vehicle's stoppage time in the station sections 611, 612 and 613 and stoppage time in the intersection sections 621 and 622 for the arrival time estimation. That is, the apparatus 700 may consider how long a vehicle stops in each station or at each intersection.

The above-described algorithms may also be applied to determine the stoppage time in the station sections 611, 612 and 613 and the stoppage time in the intersection sections 621 and 622. That is, the arrival time estimation apparatus 700 may apply the moving average or a service pattern to determine the stoppage time in the station sections 611, 612 and 613 and the stoppage time in the intersection sections 621 and 622. In addition, different algorithms may be applied according to the respective predefined sections.

For example, the arrival time estimation apparatus 700 may estimate the stoppage time in the intersection sections 621 and 622, by using a stoppage time calculated based on a service pattern associated with rush hours when the station sections 611, 612 and 613 are congested.

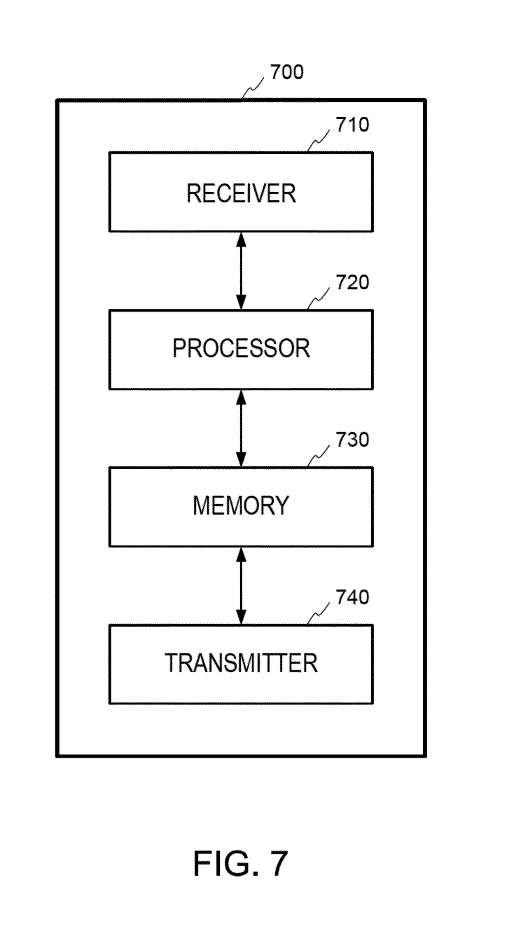

FIG. 7 is a block diagram illustrating an apparatus for estimating the arrival time of a vehicle according to an embodiment.

Referring to FIG. 7, an arrival time estimation apparatus 700 includes a receiver 710, a processor 720, a memory 730, and a transmitter 740. The arrival time estimation apparatus 700 may be located at a control facility that is separate from the plurality of vehicles 10 and the transportation information output apparatus 20. In other embodiments, the arrival time estimation apparatus 700 may be provided in the plurality of vehicles 10, or may be provided in the transportation information output apparatus 20.

The receiver 710 receives location information on the plurality of vehicles 10. The location information may include GPS information or information obtained from RFID tags installed on traveling paths.

In an embodiment, the arrival time estimation apparatus 700 includes one or more non-transitory computer-readable media. For example, in an embodiment, a non-transitory computer-readable medium may be memory, such as random access memory (RAM), read-only memory (ROM), or a higher capacity storage. Such memory is indicated in FIG. 7 as memory 730. However, embodiments are not limited thereto, and other forms of computer-readable media may be implemented in accordance with an embodiment. Memory 730 may have stored thereon computer-executable instructions, which, when executed, causes one or more processors 720 to perform various operations for estimating an arrival time of a transportation vehicle 10. In an embodiment, the executable instructions are to perform operations in accordance with embodiments described with reference to FIGS. 2 to 6 above.

The processor 720 calculates the travel times according to the moving average, the exponential smoothing, and the service pattern of the plurality of vehicles 10 with respect to a predefined section by using the travel times of the plurality of vehicles 10, which are measured with respect to the predefined section.

The predefined section may include at least one of a first section between a first intersection and a first station adjacent to the first intersection, a second section between the first intersection and a second intersection adjacent to the first intersection, and a third section between the first station and a second station adjacent to the first station. In addition, the predefined section may include a station section and an intersection section. In an embodiment, the predefined section may include the sections described above with reference to FIGS. 2 and 6. The travel time in the predefined section may include stoppage time of the vehicle at the station located at the predefined section.

The moving average may be calculated based on the cumulative operation frequency of the plurality of vehicles and the cumulative operation time of the plurality of vehicles. The travel times calculated according to the moving average and the exponential smoothing may be calculated using Formulas 1 to 3. In addition, the service pattern may include patterns of transportation provided based on seasons, weather, day of the week, time, and characteristics of the predefined sections.

In addition, the processor 720 calculates error values between the actual travel time of the first vehicle with respect to a predefined section and the travel times calculated according to the moving average, the exponential smoothing, and the service pattern.

In addition, the processor 720 estimates the travel time of a second vehicle with respect to the predefined section, based on the calculated error values. The processor 720 may estimate, as the travel time of the second vehicle, a value having the smallest error value with respect to the actual travel time of the first vehicle with respect to the predefined section among the travel times calculated according to the moving average, the exponential smoothing, and the service pattern. The processor 720 may estimate the travel time of the second vehicle with respect to the respective predefined sections using different algorithms.

The memory 730 may store the travel times of the plurality of vehicles 10, and the travel times according to the moving average, the exponential smoothing, and the service pattern of the plurality of vehicles 10.

The transmitter 740 may transmit the estimated arrival times of the plurality of vehicles 10 to the transportation information output apparatus 20.

Embodiments of the present disclosure may be implemented in the form of program commands which can be executed through various computer units, and then written to computer readable media. The computer readable media may include a program command, a data file, a data structure, or a combination thereof. Examples of a computer readable media may include magnetic media such as a hard disk, a floppy disk and a magnetic tape, optical media such as CD-ROM and DVD, magneto-optical media such as a floptical disk, and hardware devices, such as ROM, RAM and flash memory, configured to store and execute a program command. Examples of the program command may include a machine language code created by a compiler and a high-level language code executed by a computer through an interpreter or the like. The hardware device may be configured to operate as one or more software modules to perform an operation in accordance with an embodiment of the present disclosure, and vice versa.

While embodiments have been described with reference to the drawings, the present invention is not limited to the above-described embodiments, and it will be apparent to those skilled in the art that various changes and modifications may be made. For example, appropriate results can be achieved even when the above-described technologies are performed in a different order from an embodiment described above and/or when elements of a described system, structure, apparatus, and circuit are connected or combined in a different form from an embodiment described above, or are replaced or substituted by other elements or equivalents.

Thus, the scope of the present invention is not limited to the above-described embodiments, but may be defined by the following claims and equivalents to the claims.

What is claimed is:

1. A method for estimating an arrival time of a vehicle, the method comprising:
measuring travel times of a plurality of vehicles through a section in a transportation route using location information on the plurality of vehicles;
calculating travel times using at least one of a moving average, exponential smoothing, and a service pattern of the plurality of vehicles with respect to the section using the measured travel times of the plurality of vehicles;
calculating an error value between a measured travel time of a first vehicle with respect to the section and each travel time calculated using at least one of the moving average, the exponential smoothing, and the service pattern; and
estimating a travel time of a second vehicle with respect to the section, based on the calculated error value.

2. The method of claim 1, wherein the section includes at least one of a first section between a first intersection and a first station adjacent to the first intersection, a second section between the first intersection and a second intersection adjacent to the first intersection, and a third section between the first station and a second station adjacent to the first station.

3. The method of claim 2, wherein calculating the travel times comprises:
calculating travel times of the plurality of vehicles through the first section; and
calculating travel times of the plurality of vehicles through the second section and the third section, based on the travel time of the plurality of vehicles through the first section.

4. The method of claim 1, wherein the travel time through the section includes a stoppage time of a vehicle at a station located in the section.

5. The method of claim 1, wherein the moving average is calculated based on a cumulative operation frequency of the plurality of vehicles and a cumulative operation time of the plurality of vehicles.

6. The method of claim 1, wherein the service pattern includes patterns of transportation service provided based on seasons, weather, day of the week, time, and characteristics of the section.

7. The method of claim 1, wherein estimating the travel time of the second vehicle comprises:
estimating, as the travel time of the second vehicle, a value having the smallest error value with respect to the measured travel time of the first vehicle with respect to the section among the travel times calculated using the moving average, the exponential smoothing, and the service pattern.

8. The method of claim 1, further comprising:
filtering a value, which is outside of a predefined range, among the measured travel times of the plurality of vehicles.

9. The method of claim 1, further comprising:
determining a traffic condition of the section, based on the travel times calculated using the moving average, the exponential smoothing, and the service pattern.

10. An apparatus for estimating an arrival time of a vehicle, the apparatus comprising:
a processor configured to:
calculate travel times using at least one of a moving average, exponential smoothing, and a service pattern of a plurality of vehicles with respect to a section of a transportation route by using travel times of the plurality of vehicles which are measured with respect to the section;
calculate error values between a measured travel time of a first vehicle with respect to the section and the travel times calculated using at least one of the moving average, the exponential smoothing, and the service pattern; and
estimate a travel time of a second vehicle with respect to the section, based on the calculated error values.

11. The apparatus of claim 10, wherein the section includes at least one of a first section between a first intersection and a first station adjacent to the first intersection, a second section between the first intersection and a second intersection adjacent to the first intersection, and a third section between the first station and a second station adjacent to the first station.

12. The apparatus of claim 10, wherein the travel time with respect to the section includes a stoppage time of a vehicle at a station located in the section.

13. The apparatus of claim 10, wherein the moving average is calculated based on a cumulative operation frequency of the plurality of vehicles and a cumulative operation time of the plurality of vehicles.

14. The apparatus of claim 10, wherein the service pattern includes patterns of transportation service provided based on seasons, weather, day of the week, time, and characteristics of the section.

15. The apparatus of claim 10, wherein the processor is configured to estimate, as the travel time of the second vehicle, a value having the smallest error value with respect to the measured travel time of the first vehicle with respect to the section among the travel times calculated using the moving average, the exponential smoothing, and the service pattern.

16. A non-transitory computer-readable medium having stored thereon a program, which, when executed by a processor, performs a method, the method comprising:
measuring travel times of a plurality of vehicles through a section in a transportation route using location information on the plurality of vehicles;
calculating travel times using at least one of a moving average, exponential smoothing, and a service pattern of the plurality of vehicles with respect to the section using the measured travel times of the plurality of vehicles;
calculating an error value between a measured travel time of a first vehicle with respect to the section and each travel time calculated using at least one of the moving average, the exponential smoothing, and the service pattern; and
estimating a travel time of a second vehicle with respect to the section, based on the calculated error value.

17. The non-transitory computer-readable medium of claim 16, wherein the section includes at least one of a first section between a first intersection and a first station adjacent to the first intersection, a second section between the first intersection and a second intersection adjacent to the first intersection, and a third section between the first station and a second station adjacent to the first station.

18. The non-transitory computer-readable medium of claim 17, wherein calculating the travel times comprises:
calculating the travel times of the plurality of vehicles through the first section; and
calculating the travel times of the plurality of vehicles through the second section and the third section, based on the travel times of the plurality of vehicles through the first section.

19. The non-transitory computer-readable medium of claim 16, wherein estimating the travel time of the second vehicle with respect to the section comprises:
estimating, as the travel time of the second vehicle, a value having the smallest error value with respect to the measured travel time of the first vehicle with respect to the section among the travel times calculated according to the moving average, the exponential smoothing, and the service pattern.

20. The non-transitory computer-readable medium of claim 16, wherein the service pattern includes patterns of transportation service provided based on seasons, weather, day of the week, time, and characteristics of the section.
